(19) United States
(12) Patent Application Publication
(10) Pub. No.: US 2026/0070090 A1
(43) Pub. Date: Mar. 12, 2026

(54) SEPARATION DEVICE, SHEET PRODUCTION APPARATUS, AND METHOD OF PRODUCING FILTRATION PRODUCT

(71) Applicant: SEIKO EPSON CORPORATION, Tokyo (JP)

(72) Inventors: Shinichi FURIHATA, Azumino (JP); Toshizo NISHI, Azumino (JP); Naoto ARUGA, Matsumoto (JP)

(21) Appl. No.: 19/324,196

(22) Filed: Sep. 10, 2025

(30) Foreign Application Priority Data
Sep. 12, 2024 (JP) 2024-158109

(51) Int. Cl. B07B 7/06; B07B 1/38

(52) U.S. Cl. CPC B07B 7/06; B07B 1/38

(57) ABSTRACT

A separation device includes: a sieve including a mesh; a cover member forming a first chamber, a second chamber, a third chamber, and a fourth chamber on a front surface side of the sieve; a motor configured to move the front surface side of the sieve sequentially from the first chamber to the fourth chamber in order by rotating the sieve; a first pipe configured to blow air mixed with a filtration product and foreign materials toward the front surface of the sieve, in the first chamber; a second pipe located at a position facing the first chamber and configured to draw, by suction, air mixed with the foreign materials that passed through the mesh, from a back surface side of the sieve; a third pipe configured to draw, by suction, air mixed with the filtration product from the front surface of the sieve, in the third chamber; a fourth pipe located at a position facing the third chamber and configured to blow air toward the back surface of the sieve; and a moistening pipe configured to blow humidified air toward the front surface side of the sieve, in the second chamber.

The present application is based on, and claims priority from JP Application Serial Number 2024-158109, filed Sep. 12, 2024, the disclosure of which is hereby incorporated by reference herein in its entirety.

### BACKGROUND

### 1. Technical Field

The present disclosure relates to a separation device, a sheet production apparatus including the separation device, and a method of producing a filtration product.

### 2. Related Art

For example, JP-A-2019-84504 discloses a separation device in which defibrated material containing fibers is blown onto a mesh disc, which is a disc-shaped sieve provided with a mesh, and the remaining filtration product that did not pass through the mesh pattern is drawn by suction. The separation device includes a mesh disk, a defibrated material spraying pipe disposed on the front surface side of the mesh disk and configured to spray the defibrated material containing fibers, a suction pipe disposed on the back surface side of the mesh disk and configured to draw, by suction, waste powder that passed through the openings, and a recovery pipe disposed on the front surface side of the mesh disk and configured to draw, by suction, the remaining filtration product that did not pass through the openings of the mesh disk, as the processing feedstock. In addition, since the filtration product is a cotton-like product in which the defibrated material is deposited, the filtration product is charged and adheres to a pipe or the like when the filtration product is dried, and thus it is necessary to moisten the filtration product.

According to this document, the separation device is provided with a humidified air supply pipe on the back surface side of the mesh disc, and humidified air is blown out toward the back surface side of the mesh disc from the humidified air supply pipe.

However, there is room for improvement in the separation device of JP-A-2019-84504. Specifically, in a configuration in which humidified air is supplied to the back surface side of the mesh disk, there is a problem in that it is difficult to appropriately moisten the front surface side.

### SUMMARY

A separation device according to an aspect of the present application includes: a sieve including a mesh; a cover member forming a first chamber, a second chamber, a third chamber, and a fourth chamber on a front surface side of the sieve; a motor configured to move the front surface side of the sieve sequentially from the first chamber to the fourth chamber in order by rotating the sieve; a first pipe configured to blow air mixed with a filtration product and foreign materials toward the front surface of the sieve, in the first chamber; a second pipe located at a position facing the first chamber and configured to draw, by suction, air mixed with the foreign materials that passed through the mesh, from a back surface side of the sieve; a third pipe configured to draw, by suction, air mixed with the filtration product from the front surface of the sieve, in the third chamber; a fourth pipe located at a position facing the third chamber and configured to blow air toward the back surface of the sieve; and a moistening pipe configured to blow humidified air toward the front surface side of the sieve, in the second chamber.

A sheet production apparatus according to an aspect of the present application includes: the separation device mentioned above; a defibrating unit configured to defibrate a raw material; a deposition unit configured to deposit a material to form a web; and a forming unit configured to form a sheet by compressing the web, and the separation device separates the filtration product from air containing the filtration product and foreign materials obtained by defibration by the defibrating unit, and supplies the separated filtration product to the deposition unit as the material.

A method of producing a filtration product according to an aspect of the present application is a method of producing a filtration product by using a separation device including: a sieve including a mesh; a cover member forming a first chamber, a second chamber, a third chamber, and a fourth chamber on a front surface side of the sieve; a motor configured to move the front surface side of the sieve sequentially from the first chamber to the fourth chamber by rotating the sieve; a first pipe configured to blow air mixed with a filtration product and foreign materials toward the front surface of the sieve, in the first chamber; a second pipe located at a position facing the first chamber and configured to draw air by suction from a back surface side of the sieve; a third pipe configured to draw air by suction from the front surface of the sieve, in the third chamber; a fourth pipe located at a position facing the third chamber and configured to blow air toward the back surface of the sieve; and a moistening pipe configured to blow humidified air toward the front surface side of the sieve, in the second chamber, the method including: drawing, by suction, air mixed with one of the filtration product or the foreign materials that passed through the mesh, through the second pipe while supplying air mixed with the filtration product and the foreign materials from the first pipe to the front surface of the sieve; blowing the humidified air to the front surface side of the sieve through the moistening pipe when the filtration products reaches the second chamber along with the rotation of the sieve; and drawing, by suction, air mixed with the other of the filtration product and the foreign materials through the third pipe while blowing air to the sieve through the fourth pipe, when the sieve rotates.

### BRIEF DESCRIPTION OF THE DRAWINGS

FIG. 1 is a perspective view of a separation device according to Embodiment 1.

FIG. 2 is an exploded perspective view of a main part of the separation device.

FIG. 3 is a functional explanatory diagram of the separation device.

FIG. 4 is a perspective view of a cover member from below.

FIG. 5 is a plan view of the back surface of the cover member.

FIG. 6 is a plan view of the front surface of the cover member in the assembled state.

FIG. 7 is a perspective view of a moistening pipe.

FIG. 8 is a plan view of a support member.

FIG. 9 is a perspective view of the support member.

FIG. 10 is a flowchart showing a procedure for a method of producing a filtration product with the separation device.

FIG. 11 is a schematic configuration diagram of a sheet production apparatus according to Embodiment 2.

### DESCRIPTION OF EMBODIMENTS

### Embodiment 1

### Overview of Separation Device

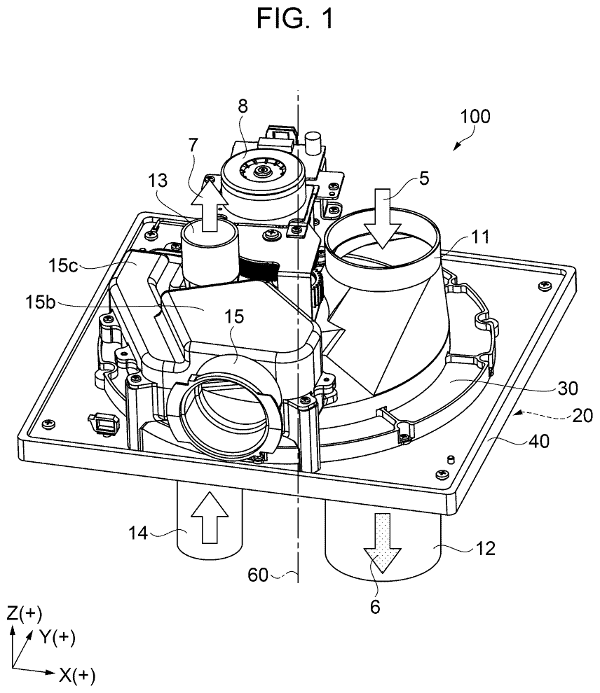

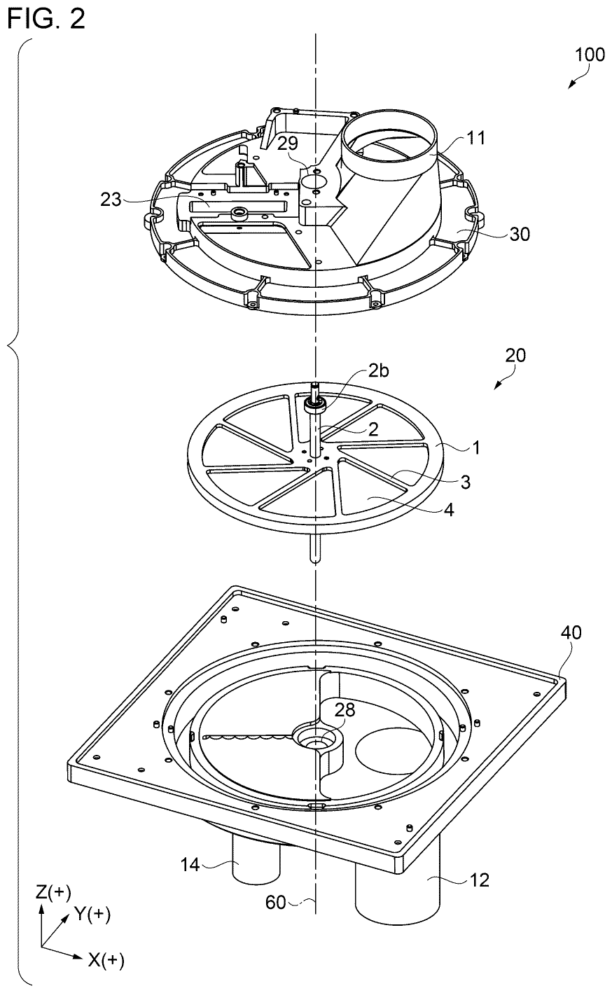

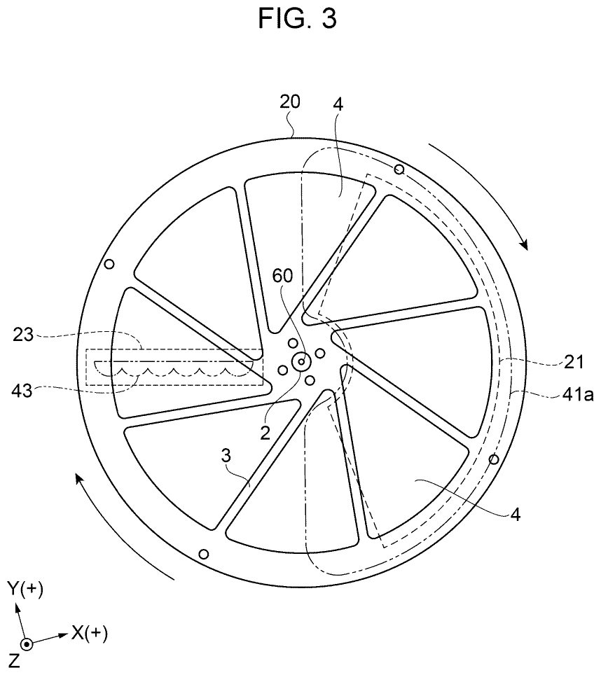

FIG. 1 is a perspective view of a separation device according to Embodiment 1. FIG. 2 is an exploded perspective view of a main part of the separation device. FIG. 3 is a functional explanatory diagram of the separation device. Hereinafter, embodiments of the present disclosure will be described with reference to the drawings.

The separation device 100 of the present embodiment shown in FIG. 1 is a dry type separation device which separates a material which can be used in a downstream process and foreign materials from a defibrated material which is a raw material supplied from an upstream process, according to the difference in size. In each of the drawings, an X axis, a Y axis, and a Z axis are illustrated as three axes orthogonal to each other. In the present embodiment, an extending direction of one side of the separation device 100 having a rectangular shape in a plan view is defined as an X plus direction, an extending direction of a side intersecting the one side is defined as a Y plus direction, and a thickness direction of the separation device 100 is defined as a Z plus direction. In a preferred example, the Z plus direction is the vertically upward direction, the Z plus direction is also referred to as the upward direction, and the Z minus direction is also referred to as the downward direction. Note that the Z plus direction is not limited to the vertically upward direction, and the installation mode of the separation device 100 can be determined as appropriate.

As shown in FIG. 2, the separation device 100 has a configuration in which a sieve 20 and a cover member 30 are stacked on a support frame 40.

The sieve 20 is a disc-shaped sieve including a mesh 4, and is provided so as to be rotatable about a rotation shaft 2. The sieve 20 is a sieve in which the mesh 4 is attached over the entire surface of a disk frame composed of an annular rim 1 and a plurality of spokes 3 connecting a central portion provided with the rotation shaft 2 and the rim 1. The rotation shaft 2 is rotatably supported by a bearing 28 in the support frame 40 and a bearing 29 in the cover member 30. A line segment parallel to the rotation shaft 2 and passing through the bearing 28 and the bearing 29 is referred to as a center line 60. In other words, the sieve 20 rotates about the center line 60. The surface of the sieve 20 on the Z plus side is also referred to as a front surface, and the surface on the Z minus side is also referred to as a back surface.

First, the function of the separation device 100 will be described with reference to FIG. 3. FIG. 3 is a view of the sieve 20 from the Z plus side. The outlines of a first chamber 21 and a third chamber 23 located on the Z plus side of the sieve 20 are indicated by broken lines, and the outlines of an opening 43 and an opening 41a located on the Z minus side of the sieve 20 are indicated by two dot broken lines.

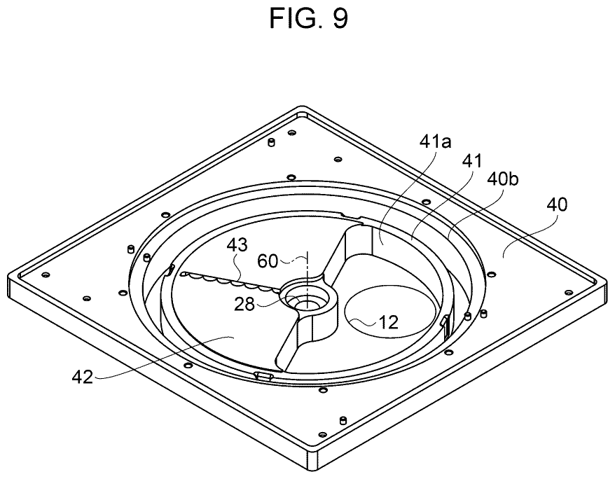

The first chamber 21 is a substantially semicircular section in a plan view, and a first pipe 11 is connected to an upper portion of the first chamber 21. The opening 41a (FIG. 9) is provided below the first pipe 11 with the sieve 20 in between. A second pipe 12 is connected to a lower portion of the opening 41a.

The third chamber 23 is a section having a rectangular shape in a plan view, and is provided at a position opposite to the first chamber 21 with the center line 60 in between. A third pipe 13 is provided above the third chamber 23. The opening 43 (FIG. 9) of a fourth pipe 14 is provided below the third pipe 13 with the sieve 20 in between.

Although not shown in FIG. 3, a second chamber 22 is a fan-shaped section centered on the center line 60 in plan view, and is provided between the first chamber 21 and the third chamber 23 on the Z plus side of the sieve 20. A fourth chamber 24 is a fan-shaped section centered on the center line 60 in plan view, and is provided between the third chamber 23 and the first chamber 21 on the Z plus side of the sieve 20.

The first chamber 21 to the fourth chamber 24 are arranged in the order of the first chamber 21, the second chamber 22, the third chamber 23, and the fourth chamber 24 clockwise around the center line 60. That is, the front surface of the sieve 20 rotates so as to sequentially come to the positions of the first chamber 21, the second chamber 22, the third chamber 23, the fourth chamber 24, and the first chamber 21. The rotation direction of the sieve 20 may be counterclockwise, and in this case, the first chamber 21 to the fourth chamber 24 are arranged counterclockwise.

In the separation device 100, air containing a raw material composed of a defibrated material is blown from the first pipe 11 to the sieve 20 through the first chamber 21. At the same time, a negative pressure is applied to the first chamber 21 from the second pipe 12 through the sieve 20. Therefore, among the raw material blown onto the mesh 4, the foreign materials that passed through the mesh pattern of the mesh 4 pass through the opening 41a and are drawn into the second pipe 12 by suction. The foreign materials drawn into the second pipe 12 by suction are collected or discarded.

The defibrated material that did not pass through the mesh pattern of the mesh 4 is deposited as a cotton-like material on the front surface of the sieve 20. The material moves, while being deposited in a strip shape on the front surface of the sieve 20 with the rotation of the sieve 20, enters the second chamber 22, and then enters the third chamber 23. That is, the mesh 4 in FIG. 3 is a mesh on the front surface of which the defibrated material is deposited.

In the second chamber 22, the material is moistened by humidified air from a moistening pipe 15 (FIG. 1). Details of the moistening will be described later.

When the material enters the third chamber 23 by the rotation of the sieve 20, the material is peeled off from the mesh 4 by the air blown from the fourth pipe 14 through the opening 43, and is drawn into the third pipe 13 by suction through the third chamber 23. At this time, the air from the fourth pipe 14 is humidified air. The air containing the material drawn into the third pipe 13 by suction is sent to a downstream process.

In this way, as shown in FIG. 1, the separation device 100 performs filtration on the raw material 5 supplied from the upstream process with the sieve 20, and separates the material 7, which is a filtration product, and foreign materials 6 according to the difference in size. The material 7 is sent to a downstream process through the third pipe 13. The foreign materials 6 are sent to a downstream process through the second pipe 12, and is collected or discarded.

### Configuration of Separation Device

The description returns to FIG. 1.

As shown in FIG. 1, a motor 8, the first pipe 11, the moistening pipe 15, the third pipe 13, and the like are provided on the cover member 30.

The motor 8 is a drive motor for the sieve 20, and rotates a pinion gear 2b of the rotation shaft 2 (FIG. 2) of the sieve 20 with the interposition of a gear train mechanism (not shown).

The first pipe 11 is formed integrally with the cover member 30 above the first chamber 21 (FIG. 3). Actually, the first pipe 11 extends to an upstream device, but illustration thereof is omitted. Other pipes similarly extend to related devices, but are not shown.

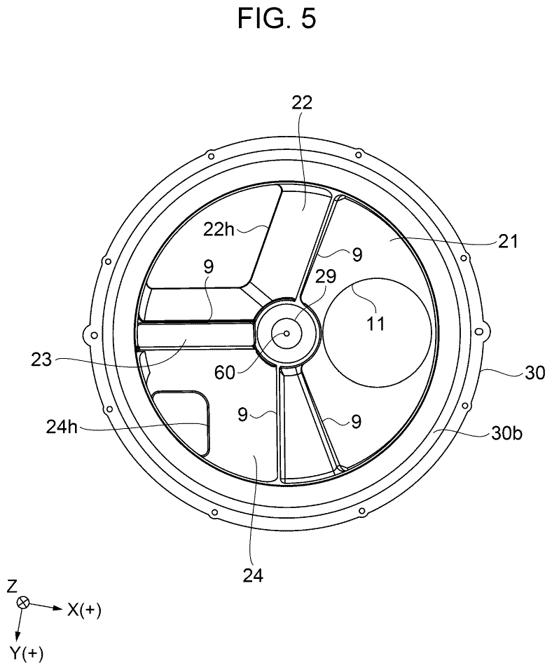

The moistening pipe 15 is connected to a humidification device (not shown), and sends humidified air supplied from the humidification device into the second chamber 22 (FIG. 5). The humidification device includes, for example, an ultrasonic humidifier and a blower, and supplies humidified air having a larger amount of moisture per unit volume than the air from the first pipe 11. The humidifier is not limited to ultrasonic humidifiers, and may be a heating humidifier or a vaporizing humidifier. In other words, the humidified air has a larger amount of moisture per unit volume than the air from the first pipe 11.

The moistening pipe 15 is integrated with a pipe cover 15b, and the pipe cover 15b covers an upper portion of the second chamber 22 (FIG. 5) and is a part of the second chamber. The pipe cover 15b is provided with a communication path 15c extending to the fourth chamber 24 (FIG. 5). Details of the communication path 15c will be described later.

The third pipe 13 is provided at a position opposite to the first pipe 11 with the center line 60 in between. As shown in FIG. 2, the outlet of the third chamber 23 of the cover member 30 has a rectangular shape, and as shown in FIG. 1, the third pipe 13 is a circular pipe having a diameter surrounding the outlet and is attached to an upper portion of the cover member 30.

As shown in FIG. 1, the second pipe 12, the fourth pipe 14, and the like are provided below the support frame 40.

The second pipe 12 is provided under the first pipe 11 with the sieve 20 in between.

The fourth pipe 14 is provided under the third pipe 13 with the sieve 20 in between. The fourth pipe 14 is connected to a humidification device (not shown), and sends the humidified air supplied from the humidification device to the third chamber 23 (FIG. 3) through the sieve 20. In a preferred example, the humidification device is the same device as the humidification device to which the moistening pipe 15 is connected.

In other words, the separation device 100 includes: the sieve 20 including the mesh 4; the cover member 30 forming the first chamber 21, the second chamber 22, the third chamber 23, and the fourth chamber 24 on the front surface side of the sieve 20; the motor 8 configured to move the front surface side of the sieve 20 sequentially from the first chamber 21 to the fourth chamber 24 by rotating the sieve 20; the first pipe 11 configured to blow air containing the raw material 5, in which a filtration product and foreign materials are mixed, toward the front surface of the sieve 20, in the first chamber 21; the second pipe 12 located at a position facing the first chamber 21 and configured to draw, by suction, air mixed with the foreign materials 6 that passed through the mesh 4, from the back surface side of the sieve 20; the third pipe 13 configured to draw, by suction, air mixed with the material 7, which is the filtration product, from the front surface of the sieve 20, in the third chamber 23; the fourth pipe 14 located at a position facing the third chamber 23 and configured to blow air toward the back surface of the sieve 20; and the moistening pipe 15 configured to blow humidified air toward the front surface side of the sieve 20, in the second chamber 22.

### Configuration of Cover Member

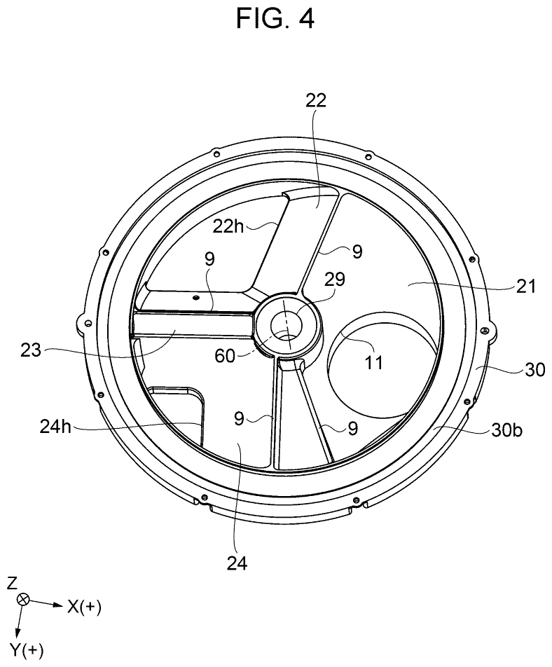

FIG. 4 is a perspective view of the cover member from below. FIG. 5 is a plan view of the back surface of the cover member. In the following description, the surface of the cover member 30 on the sieve 20 side is referred to as a back surface.

As shown in FIG. 4, the cover member 30 has a circular shape slightly larger than the sieve 20 (FIG. 2) in a plan view. An annular projection 30b slightly smaller than the outer shape is provided on the back surface of the cover member 30. The projection 30b is slightly smaller than the outer circumference of the sieve 20 (FIG. 2), and when assembled, the rim 1 of the sieve 20 rotates under the projection 30b.

As shown in FIG. 4, the first chamber 21 to the fourth chamber 24 are formed around the bearing 29 in the circular portion on the inner side of the projection 30b. The shapes and arrangements of the first chamber 21 to the fourth chamber 24 are as described with reference to FIG. 3. The first chamber 21 to the fourth chamber 24 are partitioned by a plurality of partition walls 9 radially extending from the bearing 29.

The first chamber 21 has a mortar shape with the first pipe 11 as a bottom portion.

A fan-shaped hole 22h is provided at the bottom of the second chamber 22.

A fan-shaped hole 24h is provided at the bottom of the fourth chamber 24.

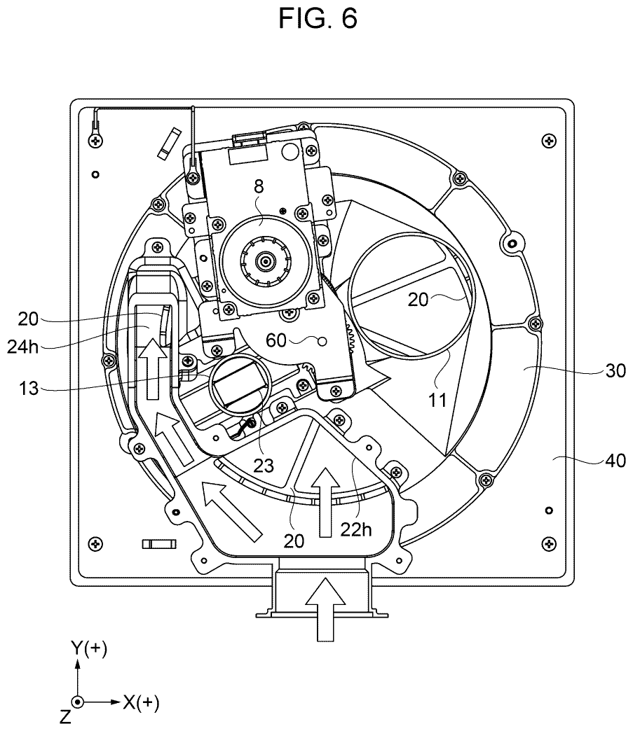

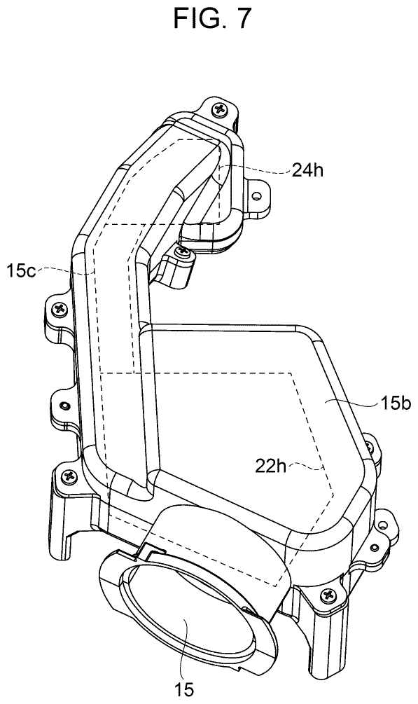

FIG. 6 is a plan view of the front surface of the cover member in the assembled state, and corresponds to FIG. 5. FIG. 7 is a perspective view of the moistening pipe.

The hole 22h in an upper portion of the second chamber 22 and the hole 24h in an upper portion of the fourth chamber 24 in the front surface of the cover member 30 shown in FIG. 6 are covered with the pipe cover 15b and the communication path 15c of the moistening pipe 15 shown in FIG. 7. The communication path 15c connects the second chamber 22 and the fourth chamber 24 at an upper portion of the cover member 30.

In FIG. 6, the flow of humidified air when the moistening pipe 15 is attached to an upper portion of the cover member 30 is indicated by white arrows. As shown in FIG. 6, the humidified air supplied from the moistening pipe 15 is blown along the front surface of the sieve 20 facing the hole 22h in the second chamber 22. A part of the humidified air from the moistening pipe 15 and the humidified air filling the second chamber 22 pass through the communication path 15c and are blown along the front surface of the sieve 20 facing the hole 24h in the fourth chamber 24.

In other words, the moistening pipe 15 further includes the communication path 15c connecting the second chamber 22 and the fourth chamber 24 on the outer side of the cover member 30, and the humidified air is blown toward the front surface side of the sieve 20 also in the fourth chamber 24 through the communication path 15c. The moistening pipe 15 blows the humidified air in a direction along the surface of the sieve 20.

By performing humidification also in the fourth chamber 24 as described above, the humidity around the sieve 20 can be kept high. As a result, even though the air containing the raw material 5 is blown to the sieve 20 when the sieve 20 is moved to the first chamber 21 again, the generation of static electricity can be suppressed, and thus the separation efficiency of the material 7 and the foreign materials 6 can be further increased.

### Configuration of Support Member

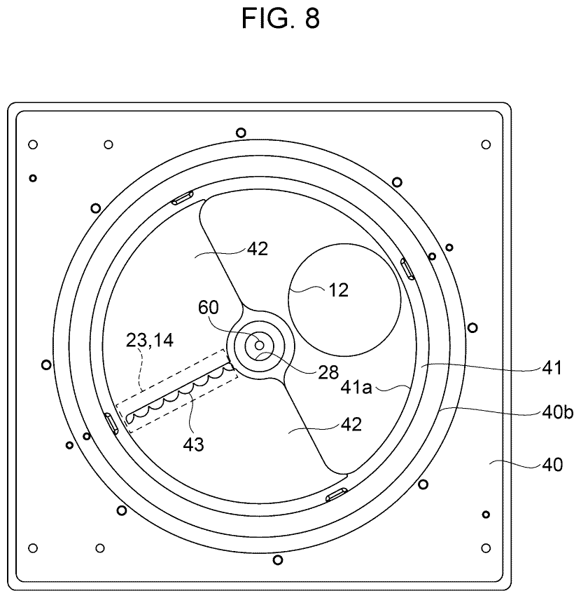

FIG. 8 is a plan view of the support member. FIG. 9 is a perspective view of the support member.

As shown in FIG. 8, the support frame 40 is provided with a circular housing portion 40b for housing the sieve 20 around the bearing 28. A cylindrical portion 41 having a circular shape slightly smaller than the housing portion 40b is provided inside the housing portion 40b.

A portion of the cylindrical portion 41 overlapping with the first chamber 21 (FIG. 3) is the semicircular opening 41a. The opening 41a is an inlet portion to the second pipe 12, has a mortar shape, and communicates with the second pipe 12 at the bottom of the mortar shape.

A top plate 42 as eaves is provided at a portion of the cylindrical portion 41 overlapping the second chamber 22 (FIG. 5) and the fourth chamber 24. The top plate 42 is positioned directly below the sieve 20 along the sieve 20 in the assembled state. In other words, the top plate 42 as eaves is provided along the sieve 20 on the back surface side of the sieve 20 in the second chamber 22.

The opening 43 in a line shape is provided in the top plate 42 of the cylindrical portion 41, overlapping the third chamber 23 (FIG. 3). The opening 43 is formed by connecting semicircular holes in a straight line. The fourth pipe 14 is provided on the back surface side of the top plate 42 opposite to the opening 43.

The humidified air supplied through the fourth pipe 14 is blown to the back surface of the sieve 20 as a curtain-like strong air flow from the opening 43. The leading end of the material deposited in a strip shape is peeled by the linear air flow. The peeled material is draw into the third pipe 13 by suction.

Here, depending on the conditions, a part of the air flow blown to the back surface of the sieve 20 from the opening 43 is sometimes diverted and travels to the second chamber 22 side. According to the experimental results of the inventors, it has been found that, in this case, when the lower portion of the second chamber 22 is a space, a part of the diverted flow becomes turbulence in the space and lifts up the deposited material. The lifted-up and peeled material moves to the peripheral portion of the sieve 20 by the centrifugal force and is caught in the gap between the outer periphery of the rim 1 and the housing portion 40b of the support frame 40, which may cause a rotation failure of the sieve 20.

However, according to the present embodiment, the top plate 42 serving as eaves is provided under the second chamber 22, and there is no air chamber in which air flows. Therefore, it is possible to prevent the occurrence of turbulence that lifts up the material.

In a preferred embodiment, the sieve 20 is made of metal, and the other parts of the separation device 100 are made of resin. However, the material is not limited thereto, and any material may be used as long as the material can withstand the pressure or negative pressure that can be generated during the separation of the sieve 20. For example, resin may be used, or all the portions may be made of metal. Which member is made of metal and which member is made of resin can be appropriately selected.

### Method of Producing Filtration Product

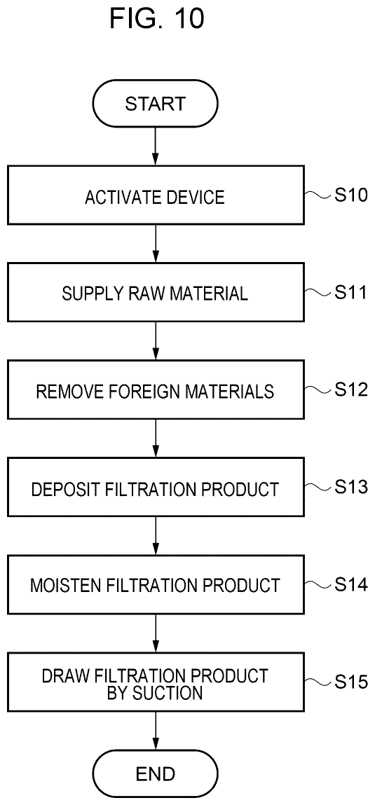

FIG. 10 is a flowchart showing a procedure for a method of producing a filtration product with the separation device.

Here, a method of producing the material 7 as a filtration product with the separation device 100 will be described mainly with reference to FIG. 10 and with reference to other drawings as appropriate.

In step S10, the separation device 100 is activated. In particular, a controller (not shown) activates the separation device 100 and associated upstream and downstream devices.

In step S11, the raw material is supplied to the separation device 100. More specifically, as shown in FIG. 1, air containing the raw material 5 composed of defibrated material is supplied from the first pipe 11 to the first chamber 21. At this time, the sieve 20 rotates at a constant speed, and a negative pressure is applied to the first chamber 21 from the second pipe 12 through the sieve 20.

In step S12, foreign materials are removed. More specifically, as shown in FIG. 3, in the raw material blown onto the mesh 4 of the sieve 20, foreign materials that passed through the mesh pattern of the mesh 4 are drawn by suction and exhausted through the second pipe 12.

In step S13, a material is deposited as a filtration product on the sieve 20. In detail, the defibrated material that did not pass through the mesh pattern of the mesh 4 is deposited on the front surface of the sieve 20 as a cotton-like material. In a preferred example, the material is mainly composed of fibers longer than the mesh pattern, but may contain particles larger than the mesh pattern.

In step S14, the material is moistened. More specifically, the material moves while being deposited in a strip shape on the front surface of the sieve 20 as the sieve 20 rotates, and when the material enters the second chamber 22, humidified air is blown to the material from the moistening pipe 15.

In step S15, the material is drawn by suction and sent to a downstream process. Specifically, when the material enters the third chamber 23 along with the rotation of the sieve 20, the material is drawn by suction through the third pipe 13. In this process, humidified air is blown to the material from the fourth pipe 14 simultaneously. As a result, since the material is drawn by suction through the third pipe 13 in a sufficiently humidified state, adhesion of the material to the inner side of the pipe due to static electricity is suppressed.

In other words, the method of producing the material 7 as a filtration product by using the separation device 100 includes: drawing, by suction, air mixed with the foreign materials 6 that passed through the mesh 4 through the second pipe 12 while supplying air containing the raw material 5 composed of defibrated material to the front surface of the sieve 20 from the first pipe 11; blowing humidified air to the front surface side of the sieve from the moistening pipe 15 when the material 7 moves along with the rotation of the sieve 20; and drawing, by suction, air mixed with the material 7 through the third pipe 13 while blowing air through the fourth pipe 14 when the sieve 20 rotates.

As described above, according to the separation device 100 and the method of producing a filtration product of the present embodiment, the following effects can be obtained.

The separation device 100 includes: the sieve 20 including the mesh 4; the cover member 30 forming the first chamber 21, the second chamber 22, the third chamber 23, and the fourth chamber 24 on the front surface side of the sieve 20; the motor 8 configured to move the front surface side of the sieve 20 sequentially from the first chamber 21 to the fourth chamber 24 by rotating the sieve 20; the first pipe 11 configured to blow air containing the raw material 5, in which a filtration product and foreign materials are mixed, toward the front surface of the sieve 20, in the first chamber 21; the second pipe 12 located at a position facing the first chamber 21 and configured to draw, by suction, air mixed with the foreign materials 6 that passed through the mesh 4, from the back surface side of the sieve 20; the third pipe 13 configured to draw, by suction, air mixed with the material 7, which is the filtration product, from the front surface of the sieve 20, in the third chamber 23; the fourth pipe 14 located at a position facing the third chamber 23 and configured to blow air toward the back surface of the sieve 20; and the moistening pipe 15 configured to blow humidified air toward the front surface side of the sieve 20, in the second chamber 22.

According to this, the separation device 100 is provided with the moistening pipe 15 for blowing humidified air to the front surface side of the sieve. In the second chamber 22 downstream of the first chamber 21, the moistening pipe 15 blows the humidified air to the material 7 deposited on the front surface of the sieve. That is, the moistening pipe 15 blows the humidified air to the deposited material 7 at a position upstream of the third chamber 23. At this time, the front surface of the sieve 20 including the filtration product is moistened.

Therefore, unlike the existing separation device in which the humidified air is blown to the back surface side of the mesh disk, the deposited filtration product can be moistened directly from the front surface side of the sieve 20. Further, since the material 7 is moistened before being drawn by suction through the third pipe 13 in the third chamber 23, the material 7 can be prevented from being dried during the rotation.

Therefore, it is possible to provide the separation device 100 capable of appropriately moistening the material 7 as the filtration product.

Further, the humidified air has a larger amount of moisture per unit volume than the air from the first pipe 11.

According to this, the material 7 as the filtration product can be appropriately moistened.

The moistening pipe 15 is further provided with the communication path 15c connecting the second chamber 22 and the fourth chamber 24 in an outer portion of the cover member 30, and blows the humidified air toward the front surface side of the sieve 20 also in the fourth chamber 24 through the communication path 15c.

According to this, by performing moistening also in the fourth chamber 24, the humidity around the sieve 20 can be kept high. Therefore, when the sieve 20 is moved to the first chamber 21 again, and air containing the raw material 5 is blown to the sieve 20, it is possible to suppress the generation of static electricity, and thus it is possible to further increase the separation efficiency of the material 7 and foreign materials 6.

The moistening pipe 15 blows humidified air in a direction along the surface of the sieve 20.

According to this, the material 7 deposited on the front surface of the sieve 20 can be efficiently moistened.

Further, the top plate 42 as eaves is provided along the sieve 20 on the back surface side of the sieve 20 in the second chamber 22.

According to this, since the top plate 42 serving as eaves is provided under the second chamber 22, and there is no air chamber that allows air to flow, it is possible to prevent the occurrence of turbulence which lifts up the material 7.

The method of producing a filtration product is a method of producing the material 7 as a filtration product by using the separation device 100 including: the sieve 20 including the mesh 4; the cover member 30 forming the first chamber 21, the second chamber 22, the third chamber 23, and the fourth chamber 24 on the front surface side of the sieve 20; the motor 8 configured to move the front surface side of the sieve 20 sequentially from the first chamber 21 to the fourth chamber 24 by rotating the sieve 20; the first pipe 11 configured to blow air containing the raw material 5, in which a filtration product and foreign materials are mixed, toward the front surface of the sieve 20, in the first chamber 21; the second pipe 12 located at a position facing the first chamber 21 and configured to draw, by suction, air mixed with the foreign materials 6 that passed through the mesh 4, from the back surface side of the sieve 20; the third pipe 13 configured to draw, by suction, air mixed with the material 7, which is the filtration product, from the front surface of the sieve 20, in the third chamber 23; the fourth pipe 14 located at a position facing the third chamber 23 and configured to blow air toward the back surface of the sieve 20; and the moistening pipe 15 configured to blow humidified air toward the front surface side of the sieve 20, in the second chamber 22, the method including: drawing, by suction, air mixed with the foreign materials 6 that passed through the mesh 4 through the second pipe 12 while supplying air containing the raw material 5 composed of defibrated material to the front surface of the sieve 20 from the first pipe 11; blowing humidified air to the front surface side of the sieve from the moistening pipe 15 when the material 7 moves along with the rotation of the sieve 20; and drawing, by suction, air mixed with the material 7 through the third pipe 13 while blowing air through the fourth pipe 14 when the sieve 20 rotates.

With this method, when the material 7 is moved with the rotation of the sieve 20, humidified air is blown to the front surface side of the sieve from the moistening pipe 15.

Therefore, unlike existing separation devices in which humidified air is blown to the back surface side of the mesh disk, the material 7 composed of a deposited filtration product can be moistened directly from the front surface side of the sieve 20. Furthermore, since the material 7 is moistened before being drawn by suction through the third pipe 13, the material 7 can be prevented from being dried during the rotation.

Therefore, it is possible to provide a method of producing a filtration product, capable of appropriately moistening the material 7 as a filtration product.

### Embodiment 2

### Application to Sheet Production Apparatus

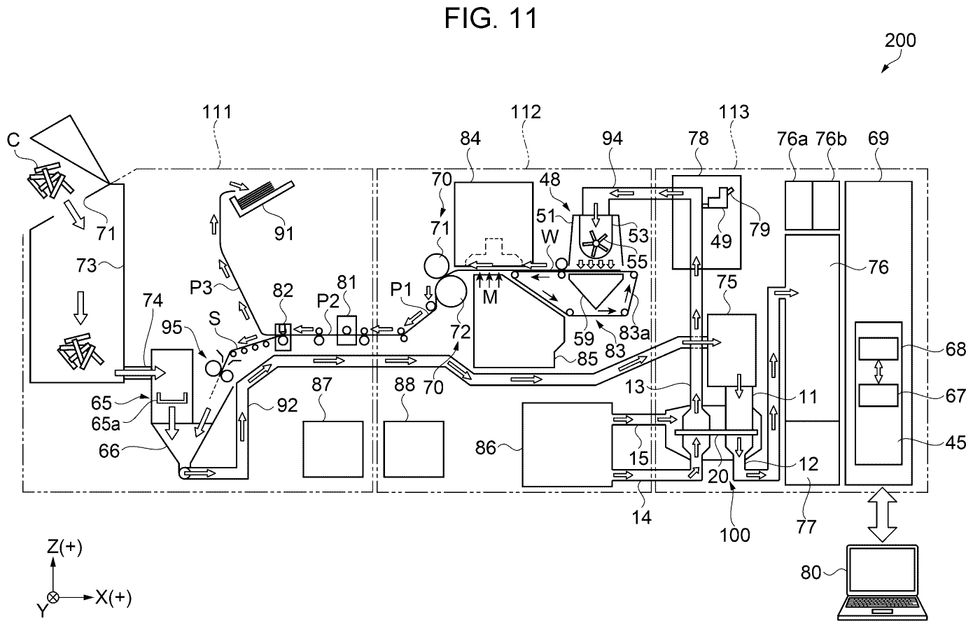

FIG. 11 is a schematic configuration diagram of a sheet production apparatus according to Embodiment 2.

The separation device 100 described above can be suitably applied to the sheet production apparatus 200.

The sheet production apparatus 200 is a sheet production apparatus that produces sheets from paper pieces C by a dry method. In a preferred embodiment, the paper pieces C are shredded waste paper and contain fibers such as cellulose. The paper pieces C may be any material containing fibers, and may be, for example, paper, pulp, pulp sheets, cloth including nonwoven fabric, or woven fabric. Further, the paper is not limited to waste paper, and may be unused paper. Further, the sheet production apparatus 200 is not limited to a dry type, and may be a wet type.

As shown in FIG. 11, the sheet production apparatus 200 includes a first unit group 111, a second unit group 112, and a third unit group 113. The first unit group 111, the second unit group 112, and the third unit group 113 are supported by a frame (not shown).

In FIG. 11, the directions in which paper pieces C, sheets P3, slit pieces S, unnecessary scraps, and the like move are indicated by white arrows. In the sheet production apparatus 200, the side in the transport direction of paper pieces C, a web W, and sheets P3 may be referred to as “downstream”, and the side in the direction opposite to the transport direction may be referred to as “upstream”. In the following description, a collection of paper pieces C composed of a plurality of paper pieces C is also simply referred to as paper pieces C.

The sheet production apparatus 200 produces sheets P3 from paper pieces C. In the sheet production apparatus 200, the first unit group 111, the second unit group 112, and the third unit group 113 are arranged from the X minus direction toward the X plus direction. The separation device 100 is housed in the third unit group 113.

Paper pieces C are stored in a storage unit 73 of the first unit group 111, and are supplied from the storage unit 73 to a merging unit 66 through a discharge portion 74 and then transported to the third unit group 113 through a pipe 92. Then, the paper pieces C are subjected to defibration and the like in the third unit group 113 to be fibers and then to be formed into a mixture containing a binder. The mixture is transported to the second unit group 112 through a pipe 94. The mixture is formed into a web W in the second unit group 112, and then formed into a sheet P1 having a strip shape. The sheet P1 having a strip shape is cut into sheets P3 in the first unit group 111.

The first unit group 111 includes the storage unit 73, a measurement unit 65, the merging unit 66, and the pipe 92. In the first unit group 111, these components are arranged in this order from upstream to downstream. In addition, the first unit group 111 includes a first cutting unit 81, a second cutting unit 82, a tray 91, and a shredding unit 95. The first cutting unit 81 and the second cutting unit 82 cut the sheet P1 having a strip shape into the sheets P3 having a predetermined shape. Furthermore, the first unit group 111 includes a water supply unit 87. The water supply unit 87 is a water storage tank. The water supply unit 87 supplies water for humidification to each of a first humidification unit 85 and a second humidification unit 86, which will be described later, through a water supply pipe (not shown).

The storage unit 73 stores paper pieces C, which are the raw material for sheets P3, and supplies the paper pieces C downstream via the discharge portion 74. The paper pieces C contain fibers such as cellulose and are, for example, shredded waste paper. The inside of the storage unit 73 is supplied with humidified air from the second humidification unit 86 included in the second unit group 112.

Paper pieces C are temporarily stored in the storage unit 73 and then transported to the measurement unit 65 via the discharge portion 74. The sheet production apparatus 200 may include a shredder located upstream of the storage unit 73 and configured to shred paper pieces C and the like.

The measurement unit 65 includes a sensor unit 65a and a supply mechanism (not shown). The sensor unit 65a measures the mass of paper pieces C. The supply mechanism supplies the paper pieces C weighed by the sensor unit 65a to the merging unit 66 located downstream. That is, in the measurement unit 65, every time the sensor unit 65a weighs out a specified mass of paper pieces C, the supply mechanism supplies it to the downstream merging unit 66.

The sensor unit 65a can employ either a digital or analog weighing mechanism. More specifically, the sensor unit 65a may be a physical sensor, such as a load cell, a spring balance, or a balance scale. In the present embodiment, the sensor unit 65a is a load cell. The predetermined mass of paper pieces C weighed by the sensor unit 65a is, for example, about several grams to several tens of grams.

The weighing and supplying processes of paper pieces C by the measurement unit 65 are batch processing. That is, the paper pieces C are intermittently supplied from the measurement unit 65 to the merging unit 66. The measurement unit 65 may include a plurality of combinations of the sensor unit 65a and the supply mechanism, and may operate the plurality of sensor units 65a at different timings, thereby improving the efficiency of the weighing and supplying processes. In a preferred example, the sheet production apparatus 200 includes two sensor units 65a, each of which is provided with a supply mechanism. Accordingly, paper pieces C are transported alternately from the two pairs of sensor unit 65a and supply mechanism to the merging unit 66.

In the merging unit 66, shredded pieces of slit pieces S supplied from the shredding unit 95 are added to and mixed with the paper pieces C supplied from the measurement unit 65. Details of the slit pieces S and the shredding unit 95 will be described later. The paper pieces C mixed with the above-mentioned shredded pieces flow from the merging unit 66 into the pipe 92.

The pipe 92 transports the paper pieces C from the first unit group 111 to the third unit group 113 via the second unit group 112, using a suction airflow generated by a defibrating unit 75 located downstream.

The third unit group 113 includes the defibrating unit 75, the separation device 100, a mixing unit 78, a waste-powder collection unit 76, and a power supply unit 69.

The paper pieces C transported through the pipe 92 flow into the defibrating unit 75. The defibrating unit 75 is a dry defibrator, and defibrates the paper pieces C supplied from the measurement unit 65 into fibers by a dry process. A known defibrating mechanism can be used as the defibrating unit 75.

The defibrating unit 75 has a configuration, for example, described below. The defibrating unit 75 includes a stator and a rotor. The stator has a substantially cylindrical inner surface. The rotor is located inside the stator and rotates along the inner surface of the stator. Small pieces of paper pieces C are caught between the inner surface of the stator and the rotor, and is defibrated by a shearing force generated therebetween. As a result, the paper pieces C become the row material 5 (FIG. 1) containing entangled defibrated material contained in the paper pieces. The paper pieces C are formed into fibers and transported to the separation device 100.

As shown in FIG. 11, air containing the raw material is supplied from the first pipe 11 to the separation device 100. The separation device 100 is the above-described separation device, filters the raw material with the sieve 20, and separates a material which is a filtration product and foreign materials according to the difference in size. Specifically, relatively long fibers and relatively short fibers are separated, the long fibers are regarded as a material, and the short fibers are regarded as foreign materials. The foreign materials also include color materials and additives contained in the paper pieces C.

The fourth pipe 14 and the moistening pipe 15 of the separation device 100 are connected to the second humidification unit 86. Thus, the humidified air from the moistening pipe 15 is blown to the material deposited on the front surface of the sieve 20. Further, the humidified air is blown from the fourth pipe 14 to the back surface side of the sieve 20. The second humidification unit 86 includes an ultrasonic humidifier and a blower, and supplies humidified air having a larger amount of moisture per unit volume than the air from the first pipe 11. The second humidification unit 86 is not limited to the ultrasonic type, and needs only to have an equivalent humidifying function. For example, the second humidification unit 86 may include a heating type or vaporizing type humidifier.

The material that is the filtration product deposited on the sieve 20 is transported to the mixing unit 78 through the third pipe 13. Specifically, the material mentioned above is transported by suction to the mixing unit 78 through the third pipe 13 by an airflow generated by a blower (not shown) provided on the distal end side of the third pipe 13.

Then, the air containing the foreign materials is introduced into the waste-powder collection unit 76 through the second pipe 12. The foreign materials are also referred to as waste powder.

The waste-powder collection unit 76 is a bag filter and includes a blower 76a for generating an exhaust flow and a compressor 76b for generating compressed air for cleaning the filter. A plurality of filters (not shown) are provided in the waste-powder collection unit 76, and foreign materials in the gas is removed by the filters. The exhaust gas from which the foreign materials have been removed is discharged from an exhaust port (not shown). The foreign materials are collected in a waste powder box 77 provided under the waste-powder collection unit 76.

The mixing unit 78 mixes a powder additive, such as a binder, with the fibers in air to form a mixture. The mixing unit 78 includes a powder supply mechanism 49. The powder supply mechanism 49 includes a built-in hopper. The powder supply mechanism 49 is equipped with a powder supply container 79. Although not illustrated, the mixing unit 78 includes a flow path through which the fibers are transported, a valve, and a fan, in addition to the powder supply mechanism 49.

The hopper sends out powder of the binder supplied from the powder supply container 79 into the flow path. In the sheet production apparatus 200, starch is used as a binder for fibers. The valve (not illustrated) adjusts the flow rate, that is, the mass of the binder supplied from the hopper into the flow path. As a result, the mixing ratio between the fibers and the binder is adjusted. Note that the mixing unit 78 may include a similar structure that supplies a colorant, an additive, or the like, in addition to the powder supply container 79 and the powder supply mechanism 49 that supply the binder. The fan of the mixing unit 78 mixes the binder and the like in air to form a mixture while transporting the fibers downstream by the generated airflow. The mixture flows from the mixing unit 78 into the pipe 94.

The power supply unit 69 includes a power supply device (not shown) that supplies power to a control board 45 and the sheet production apparatus 200. The power supply unit 69 distributes the electric power supplied from the outside to each component of the sheet production apparatus 200.

The above-mentioned control unit 67, a storage unit 68, and the like are mounted on the control board 45. In a preferred example, the control unit 67 and the storage unit 68 also have a function of integrally controlling the entire sheet production apparatus 200.

The control board 45 may be connected to a computer 80. The computer 80 is, for example, a laptop computer, and stores a control program for the entire sheet production apparatus 200 including the separation device 100.

The second unit group 112 deposits and compresses the mixture containing fibers to form the sheet P1 having a strip shape, which is recycled paper. The second unit group 112 includes a deposition unit 48, a first transport unit 83, a second transport unit 84, the first humidification unit 85, the second humidification unit 86, a drainage unit 88, and a forming unit 70.

In the second unit group 112, the deposition unit 48, the first transport unit 83, the second transport unit 84, the first humidification unit 85, and the forming unit 70 are arranged in this order from upstream to downstream. The second humidification unit 86 is disposed below the first humidification unit 85.

The deposition unit 48 deposits the mixture containing the separated fibers in air to produce a web W. The deposition unit 48 includes a drum member 53, a blade member 55 disposed inside the drum member 53, a housing 51 that houses the drum member 53 and a suction unit 59. The mixture is fed into the drum member 53 through the pipe 94.

The first transport unit 83 is disposed below the deposition unit 48. The first transport unit 83 includes a mesh belt 83a and five tension rollers (not shown) for stretching the mesh belt 83a. The suction unit 59 is disposed to face the drum member 53 with the mesh belt 83a therebetween in the Z-axis direction.

The blade member 55 is disposed inside the drum member 53 and is rotationally driven by a motor (not shown). The drum member 53 is a semicircular cylindrical sieve. The drum member 53 has a mesh having a function of a sieve on a side surface facing downward. The drum member 53 allows particles such as fibers or the mixture smaller than the mesh openings of the sieve to pass therethrough from the inside to the outside.

The mixture is discharged to the outside of the drum member 53 while being stirred by the rotating blade member 55 in the drum member 53. The inside of the drum member 53 is supplied with humidified air by the second humidification unit 86.

The suction unit 59 is disposed below the drum member 53. The suction unit 59 draws the air inside the housing 51 by suction through a plurality of holes formed in the mesh belt 83a. The plurality of holes of the mesh belt 83a allow air to pass therethrough, but do not allow the fibers, the binder, and the like contained in the mixture to pass therethrough easily. Accordingly, the mixture discharged to the outside of the drum member 53 is drawn downward by suction together with the air. The suction unit 59 is a known suction device such as a blower.

The mixture is dispersed in the air inside the housing 51 and is deposited on the upper surface of the mesh belt 83a by gravity and the suction force applied by the suction unit 59, thereby forming the web W.

The mesh belt 83a is an endless belt and is stretched around the five tension rollers. The mesh belt 83a is rotated counterclockwise in FIG. 11 by the rotation of the tension rollers. As a result, the mixture is continuously deposited on the mesh belt 83a to form a web W. The web W contains a relatively large amount of air and is soft and swollen. The first transport unit 83 transports the formed web W downstream by the rotation of the mesh belt 83a.

The second transport unit 84, located downstream of the first transport unit 83, takes over the transport of the web W from the first transport unit 83. The second transport unit 84 separates the web W from the upper surface of the mesh belt 83a and then transports the web W to the forming unit 70. The second transport unit 84 is disposed above the transport path of the web W and slightly upstream of the return start point of the mesh belt 83a. A +X direction side of the second transport unit 84 overlaps a −X direction side of the mesh belt 83a in the vertical direction. The second transport unit 84 includes a transport belt, a plurality of rollers, and a suction mechanism, which are not illustrated. The transport belt is provided with a plurality of holes that allow air to pass therethrough. The transport belt is stretched around the plurality of rollers and is rotated by the rotation of the rollers.

In the second transport unit 84, negative pressure generated by the suction mechanism attracts and attach the upper surface of the web W to the lower surface of the transport belt. When the transport belt rotates in this state, the web W, attached to the transport belt by suction, is transported downstream.

The first humidification unit 85 is a humidification device similar to the second humidification unit 86, and moistens the web W containing fibers deposited in the deposition unit 48 of the second unit group 112. Specifically, the first humidification unit 85 is disposed below the second transport unit 84, and moistens the web W being transported by the second transport unit 84 by supplying the mist M from below.

Moistening the web W with the mist M improves the function of the starch as the binder, and increases the strength of the sheets P3. In addition, since the web W is moistened from below, droplets derived from the mist are prevented from falling onto the web W. Furthermore, since the web W is moistened from the side opposite to the contact surface between the transport belt and the web W, sticking of the web W to the transport belt is reduced. The second transport unit 84 transports the web W to the forming unit 70.

The forming unit 70 includes processing rollers 71 and 72. The processing rollers 71 and 72 compress the web W containing fibers to form the sheet P1 having a strip shape. The processing rollers 71 and 72, forming a pair, each include a built-in electric heater and have functions of raising the temperature of the roller surfaces.

The processing rollers 71 and 72 are members each having a substantially cylindrical shape. The rotation axes of the processing rollers 71 and 72 extend parallel to the Y-axis. The processing roller 71 is disposed substantially above the transport path of the web W, whereas the processing roller 72 is disposed substantially below the transport path. The processing rollers 71 and 72 are disposed with a gap between the side surfaces thereof. The size of the gap is set in accordance with the thickness of the sheet P3 to be manufactured.

The processing rollers 71 and 72 are rotationally driven by a stepping motor (not shown). The web W is fed downstream, while being pinched between the processing roller 71 and the processing roller 72 and heated and pressed. That is, the web W continuously passes through the forming unit 70 and is press-formed while being heated. By using the processing rollers 71 and 72 as a pair of forming members, the web W can be efficiently heated and pressed.

When the web W, which is soft and contains a large amount of air, passes through the forming unit 70, the amount of air in the web W decreases, and the fibers therein are bound together by the binder. In this way, the web W is formed into the sheet P1 having a strip shape. The strip-shaped sheet P1 is transported to the first unit group 111 by transporting rollers (not shown).

The second humidification unit 86 is disposed below the first humidification unit 85. The second humidification unit 86 supplies humidified air to the storage unit 73, the separation device 100, the drum member 53 of the deposition unit 48, and the like.

The drainage unit 88 is a drainage tank. The drainage unit 88 collects and stores waste water after being used by the first humidification unit 85, the second humidification unit 86, and the like. The drainage unit 88 can be removed from the sheet production apparatus 200 as necessary, and the collected water can be discarded.

The sheet P1 having a strip shape transported to the first unit group 111 reaches the first cutting unit 81. The first cutting unit 81 cuts the strip-shaped sheet P1 in a direction intersecting the transport direction, for example, the direction parallel to the Y-axis. The sheet P1 having a strip shape is cut into cut sheets P2 by the first cutting unit 81. The cut sheets P2 are transported from the first cutting unit 81 to the second cutting unit 82.

The second cutting unit 82 cuts the cut sheets P2 in a direction parallel to the transport direction. More specifically, the second cutting unit 82 cuts portions of the cut sheets P2 near both sides in the direction parallel to the X-axis. As a result, the cut sheets P2 are formed into sheets P3 having a predetermined shape such as A4 size or A3 size, for example.

When the cut sheets P2 are cut into the sheets P3 in the second cutting unit 82, scrap slit pieces S are produced. The slit pieces S are transported downward to the shredding unit 95, which is a shredder. The shredding unit 95 shreds the slit pieces S into shredded pieces and supplies the shredded pieces to the merging unit 66. A mechanism for weighing the shredded pieces of the slit pieces S and supplying the shredded pieces to the merging unit 66 may be provided between the shredding unit 95 and the merging unit 66.

The sheets P3 are transported substantially upward and are stacked on the tray 91. As described above, the sheets P3 are manufactured by the sheet production apparatus 200. The sheets P3 can be used as a substitute for, for example, copy paper or the like.

In other words, the sheet production apparatus 200 includes the separation device 100, the defibrating unit 75 that defibrates the raw material, the deposition unit 48 that deposits the material and forms the web W, and the forming unit 70 that compresses the web W and forms the sheet, and the separation device 100 separates the filtration product from the air containing the raw material obtained by defibration by the defibrating unit 75 and supplies the separated filtration product to the deposition unit 48 as the material.

As described above, according to the sheet production apparatus 200 of the present embodiment, the following effects can be obtained.

The sheet production apparatus 200 includes: the separation device 100; the defibrating unit 75 configured to defibrate the raw material; the deposition unit 48 configured to deposit the material to form the web W; and the forming unit 70 configured to form the sheet by compressing the web W, and the separation device 100 separates the filtration product from the air containing the raw material obtained by defibration by the defibrating unit 75, and supplies the separated filtration product to the deposition unit 48 as the material.

According to this, the sheet production apparatus 200 is provided with the separation device 100 capable of appropriately moistening the material 7 as the filtration product.

Therefore, it is possible to provide a sheet production apparatus 200 which has a high efficiency of separating the material and foreign materials and can produce sheets having a good quality.

Since the embodiment described above is based on an example in which the target substance to be obtained by the filtration is a fiber material that does not pass through the openings of the mesh 4, what did not pass through the openings of the mesh 4 is referred to as a filtration product, and what passed through the openings of the mesh 4 is referred to as foreign materials. However, when the target substance to be obtained by the filtration is what passes through the openings of the mesh 4, what passed through the openings of the mesh 4 may be referred to as a filtration product, and what did not pass through the openings of the mesh 4 may be referred to as foreign materials. Further, when it is desired to separately obtain both the substance which passes through the openings of the mesh 4 and the substance which does not pass through the openings of the mesh 4, one of them may be referred to as a filtration product, and the other may be referred to as foreign materials.

What is claimed is:

1. A separation device comprising:
a sieve including a mesh;
a cover member forming a first chamber, a second chamber, a third chamber, and a fourth chamber on a front surface side of the sieve;
a motor configured to move the front surface side of the sieve sequentially from the first chamber to the fourth chamber in order by rotating the sieve;
a first pipe configured to blow air mixed with a filtration product and foreign materials toward the front surface of the sieve, in the first chamber;
a second pipe located at a position facing the first chamber and configured to draw, by suction, air mixed with the foreign materials that passed through the mesh, from a back surface side of the sieve;
a third pipe configured to draw, by suction, air mixed with the filtration product from the front surface of the sieve, in the third chamber;
a fourth pipe located at a position facing the third chamber and configured to blow air toward the back surface of the sieve; and
a moistening pipe configured to blow humidified air toward the front surface side of the sieve, in the second chamber.

2. The separation device according to claim 1, wherein
the humidified air has a larger amount of moisture per unit volume than the air from the first pipe.

3. The separation device according to claim 1, wherein
the moistening pipe is further provided with a communication path that connects the second chamber and the fourth chamber, at an outer portion of the cover member, and
the moistening pipe blows the humidified air through the communication path toward the front surface side of the sieve also in the fourth chamber.

4. The separation device according to claim 3, wherein
the moistening pipe blows the humidified air in a direction along the front surface of the sieve.

5. The separation device according to claim 1, wherein:
eaves are provided along the sieve, on the back surface side of the sieve in the second chamber.

6. A sheet production apparatus comprising:
the separation device according to claim 1;
a defibrating unit configured to defibrate a raw material;
a deposition unit configured to deposit a material to form a web; and
a forming unit configured to form a sheet by compressing the web, wherein
the separation device separates the filtration product from air containing the filtration product and foreign materials obtained by defibration by the defibrating unit, and supplies the separated filtration product to the deposition unit as the material.

7. A method of producing a filtration product by using a separation device including:
a sieve including a mesh;
a cover member forming a first chamber, a second chamber, a third chamber, and a fourth chamber on a front surface side of the sieve;
a motor configured to move the front surface side of the sieve sequentially from the first chamber to the fourth chamber by rotating the sieve;
a first pipe configured to blow air mixed with a filtration product and foreign materials toward the front surface of the sieve, in the first chamber;
a second pipe located at a position facing the first chamber and configured to draw air by suction from a back surface side of the sieve;
a third pipe configured to draw air by suction from the front surface of the sieve, in the third chamber;
a fourth pipe located at a position facing the third chamber and configured to blow air toward the back surface of the sieve; and
a moistening pipe configured to blow humidified air toward the front surface side of the sieve, in the second chamber, the method comprising:
drawing, by suction, air mixed with one of the filtration product or the foreign materials that passed through the mesh, through the second pipe while supplying air mixed with the filtration product and the foreign materials from the first pipe to the front surface of the sieve;
blowing the humidified air to the front surface side of the sieve through the moistening pipe when the filtration products reaches the second chamber along with the rotation of the sieve; and
drawing, by suction, air mixed with the other of the filtration product and the foreign materials through the third pipe while blowing air to the sieve through the fourth pipe, when the sieve rotates.
